(19) United States
(12) Patent Application Publication
(10) Pub. No.: US 2005/0246733 A1
(43) Pub. Date: Nov. 3, 2005

(54) Method and system for directing interactive tv game shows

(76) Inventor: Carolina Adriana Pijper, Hh Utrecht (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/526,212

(22) PCT Filed: Aug. 29, 2003
(86) PCT No.: PCT/EP03/09735

§ 371 Date: Mar. 3, 2005

(30) Foreign Application Priority Data
Aug. 30, 2002 (US) 60407777

(51) Int. Cl. H04N 7/173; H04H 9/00; H04N 7/16

(52) U.S. Cl. 725/24; 725/13; 725/112; 725/113

(57) ABSTRACT

The present invention discloses a method of directing an interactive broadcast with participation of a plurality of participants without the risk of peakload problems. This aim is reached by splitting up the downloading of the relevant interactive application over time, and by directing the moments off interaction between the participants and the interactive system. The part requiring most capacity is downloaded some time before or during the actual broadcast, and not by all participants at the same time. In addition each participant is allocated a time slot in which it is allowed to send in the answers.

### FIELD OF THE INVENTION

The present invention is related to an advanced TV broadcasting system, in particular to a system for facilitating viewer participation in a TV game show using the Internet.

### BACKGROUND OF THE INVENTION

There is a need to involve TV subscribers more actively in TV programs. Usually this requires the use of special network appliances like digital set-top boxes. The penetration of digital setup boxes in the homes goes slowly. Therefore TV producers are looking for other ways to engage viewers in TV programs. Using the Internet to provide viewers of TV programs with extra information is a possibility since the Internet is widely available. TV productions also want to have the viewers interact with the TV broadcast by using the Internet. The true integration of an on line Internet event and a TV broadcast presents program makers with a lot of practical and technical problems, like the problem of really synchronizing the course of both programs. WO0139506 discloses a system that allows large numbers of participants to engage in on-line, multi-participant shows that are synchronized to broadcasts of prerecorded or live shows and also simultaneously aggregates participant input from such shows and feeds it back into the broadcast. A problem, not addressed by WO0139506, is the limited capacity of the computer networks available for the on-line participation of viewers at home. When all participants would try to interact at the same time, the system could crash due to lack of capacity.

### PROBLEM DEFINITION

Thus the prior art fails to disclose a solution to produce broadcast where a plurality of TV viewers simultaneously participate actively in the broadcast, while avoiding major operational problems like peak load.

### AIM OF THE INVENTION

The aim of the invention is to provide a method of producing an interactive broadcast, where a plurality of TV viewers can actively participate in the broadcast, using a variety of devices, without operational risks such as peak loads during downloading the interactive application or sending in the answers and results.

### SUMMARY OF THE INVENTION

The present invention provides a method for directing a broadcast with interaction of a plurality of participants, avoiding capacity problems. This aim is reached by splitting up the downloading and running of the interactive part of the show over time. The part that requires a lot of system capacity for example because it contains a lot of Mbites, can be downloaded some time before the actual broadcast and is not downloaded by all participants at the same time. This has the advantage that a peakload problem is avoided.

In a first aspect of the invention a method of directing a broadcast with participation of a plurality of participants through the use of an interactive application on a participant device is disclosed, comprising the steps of:
first downloading the main part of the interactive application before or during the actual broadcast on the devices of the participant, so that not all participants download the application at the same time; the participants can then use the interactive application off-line on their particpant device during the broadcast; the answers the participant give are registered off-line on the device; finally the participant sends his input, during or after the broadcast.

The method can also have a step for collecting the individual answers from all participants and analyzing the answers. The resulting scores can be delivered to both the individual participants and to the producers of the broadcast.

The interactive application may comprise synchronization information. In case the synchronization information is not known at the time of download or changes after download, the participant can also separately download the synchronization information shortly before the broadcast, or when the broadcast has already started. Since the synchronization information does not form a big part of the interactive application, and will only comprise a limited amount of Kbits of information to be downloaded, this will still not lead to peakload problems, even when more participants are downloading this part at the same time.

To avoid peakload problems at the end of the broadcast, when all participants will send in their answers, is advantageous to include in the interactive application, that will be downloaded, information about a time slot, during which the application is allowed to send in the answers from the participant. This time slot could be a period of time during or after the broadcast.

An Internet site might be used for facilitating the downloading of the interactive application, which the participant can use with a device that is capable of interacting through the Internet, for example a personal computer, a small Internet enabled device, like a PDA or a mobile phone capable of communication via the Internet, using e.g. WAP, UMTS or any other suitable protocol. The participant could also use his TV set to download the interactive application.

The invention also relates to systems that are used to carry out the method for directing an interactive broadcast.

### BRIEF DESCRIPTION OF THE DRAWINGS

The invention will be explained in greater detail by reference to exemplary embodiments shown in the drawings, in which:

FIG. 1 shows a system diagram of an exemplary embodiment of the invention.

FIG. 2 shows a flow chart according to an exemplary embodiment of the invention.

### DETAILED DESCRIPTION OF THE INVENTION

For the purpose of teaching of the invention, preferred embodiments of the method and system of the invention are described in the sequel. It will be apparent to the person skilled in the art that other alternative and equivalent embodiments of the invention can be conceived and reduced to practice without departing from the true spirit of the invention, the scope of the invention being limited only by the appended claims.

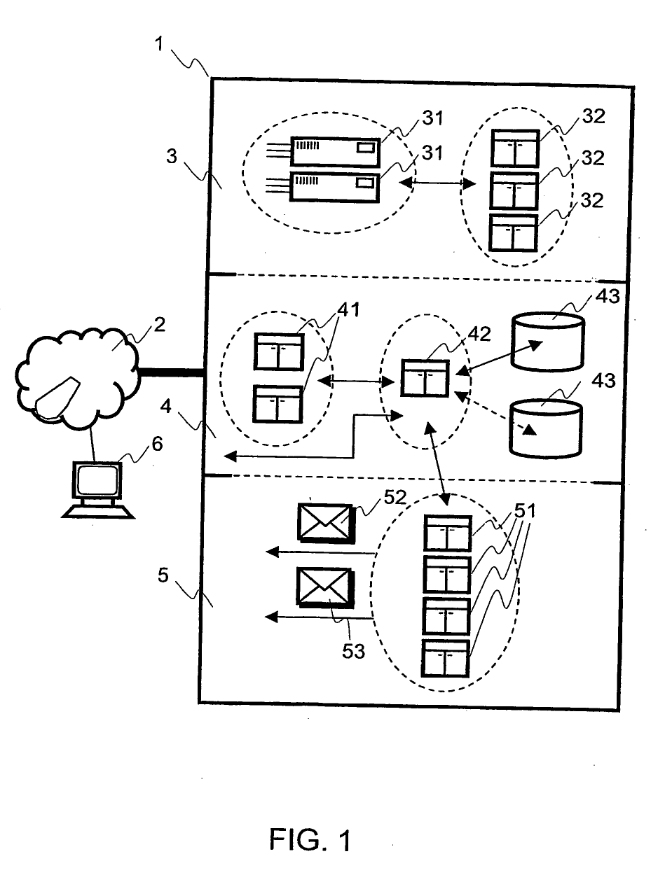

FIG. 1 shows a system (1) for directing the interactive part of a broadcast show. The system is connected to the participants at home (6) via a communications network (2), e.g. the Internet. The system comprises three subsystems, the application download system (3), the registration system (4) and the score delivery system (5). The application download system (3) comprises one or more proxy servers (31) to communicate with the participants and one or more webservers (32) for providing information about the broadcast show and facilitating downloading of the application. The registration system (4) comprises one or more proxy servers (41) to communicate with the participants, one or more CGI servers (42) to execute the registration process of participant details and results and providing the results from the database (43) to the score delivery system (5), and one or more databases (43) for storing participant details and results. The score delivery system. (5) comprises one or more mail servers (51) for sending the participant scores by email to the participants (52) and to the broadcast studio (53). The participants at home (6) use a device capable of communicating through the Internet, e.g. a personal computer or a mobile phone.

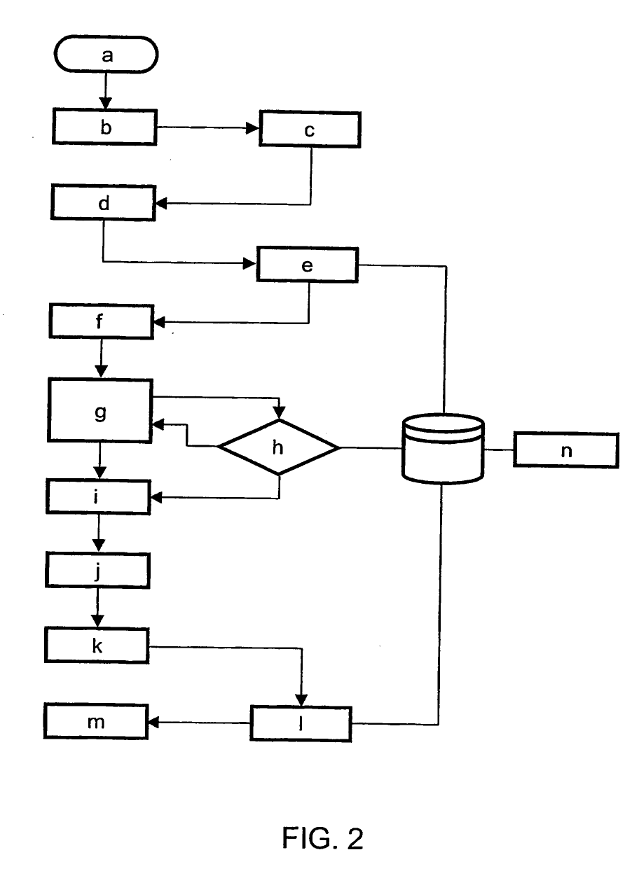

The invention will be further explained with reference to the flowchart of FIG. 2.

The invention relates to broadcast shows that have been recorded some time before the show is actually broadcasted. Some time before the actual broadcast of the show, the potential audience is informed about the intended broadcast of the show with special commercial messages. In these messages the audience is also informed of the fact that the TV viewers at home can participate in the show, and they are referred to the relevant Internet site of the show on the system (1).

On the Internet site the participant receives further information about the show and the interactive part of it, step a. If the participant decides that he would like to participate during the broadcast of the show he requests a registration form in step b. An HTML or flash registration page is sent to the participant (step c) and in step d the participant enters his personal information, including but not limited to his email address in registration system (4). On reception of the participant information a participant entry is made in the database (43) and a password is sent to the participant, step e. The advantage of registering all potential participants in registration system (4) is that the necessary capacity for equipment can be taken care of in advance, and in the event too many participants try to register, the production company can decide to close registration, or in the event only a limited number of people register themselves as participants the commercial messages with regard to the show can be repeated once more.

The participant can now decide to download the Internet application installation package from the download application system (3), and run the installation, step f. This installation package includes the heavy part of the application. By providing the possibility to download this part of the software more than a week before the actual broadcast the potential participants will not download the software simultaneously, avoiding a peak load problem shortly before the start of the show.

The possibility to download the Internet application is closed approximately 3 hours before the start of the show.

Registered participants are asked to log on into the Internet application of the game show during the last three hours before the show is scheduled to start, step g. The TV game show has been recorded by then, and all timing details are known. After validation of participant name and password, in step i, the participant receives in step h the participant code and the URL link to now download the last part of the application from application download system (3), containing the questions, the synchronization information and a time slot for submitting the answers after the show. After the participant has downloaded this part of the application, and has disconnected from the Internet, the off-line count down to the start of the broadcast of the show starts, step j. Exactly at the same time the TV broadcast and the now local off-line application start. The participant can view the show, participate and fill in his answers to the questions, at exactly the same time as the contestants in the show on TV. The answers to the questions are recorded locally on the participant's device.

After the show is ended the participant can submit his answers after the final question, step k. Again to avoid peak load at the end of the show, when all participants might sent in their results at exactly the same time, the local interactive application received a time slot during download. This means that the exact moment of submitting the results is directed in the software to avoid peak load and possible subsequent crashing of the system.

The next step (1) is registration system (4) saving the results of the participants at home in the database (43), and score delivery system (5) calculating their personal results and sending a “thank you” message with the results to the participants, step m. In the next step (n) the results and scores of all participants are processed by score delivery system (5) in the format requested by the producer of the show, so that the results of the home participants can be compared with the results of the contestants in the studio.

1. A method of directing a broadcast with participation of a plurality of participants through the use of an interactive application on a participant device, comprising the steps of:
downloading said interactive application on said participant device;
using said interactive application off-line on said participant device, synchronized with the broadcast;
registering participant input on said participant device;
submitting said participant input.

2. A method according to claim 1 also comprising the steps of:
collecting and analyzing all participant input and
delivering the results of said analyzing to all participants.

3. A method according to claim 1 in which said downloading of said interactive application takes place before said broadcast.

4. A method according to claim 1 in which said submitting of said participant input takes place after said broadcast has ended.

5. A method according to claim 1 in which said interactive application comprises synchronization information.

6. A method according to claim 5 in which said interactive application and said synchronization information are downloaded on separate points in time.

7. A method according to claim 1 in which said interactive application comprises a time slot for said submitting of the participant input.

8. A method according to claim 1 in which said interactive is downloaded from the Internet site of said broadcast.

9. A method according to claim 1 in which said participant device is capable of communicating through the Internet.

10. A method according to claim 1 in which said broadcast is a TV game show.

11. A system for directing a broadcast with participation of a plurality of participants through the use of an interactive application on a participant device, comprising:
a downloading application system for providing said interactive application to said participants before the actual broadcast;
a registration system for registering participant input.

12. A system according to claim 11 also comprising a score delivery system for analyzing participant input and delivering the results of said analyzing to all participants.

13. A system according to claim 11 in which said participants are connected to said system through the Internet.
